(19) United States
(12) Patent Application Publication
(10) Pub. No.: US 2025/0266666 A1
(43) Pub. Date: Aug. 21, 2025

(54) APPARATUSES AND METHODS FOR REMOVING LINE SPACERS

(71) Applicant: FT Holdings Inc., Calgary (CA)

(72) Inventors: Daniel John CLARKE, Calgary (CA); Hewson Charles ELLIOTT, Calgary (CA)

(73) Assignee: FT Holdings Inc., Calgary (CA)

(21) Appl. No.: 19/051,735

(22) Filed: Feb. 12, 2025

Related U.S. Application Data
(60) Provisional application No. 63/554,056, filed on Feb. 15, 2024.

(51) Int. Cl. H02G 1/02; H02G 7/12

(52) U.S. Cl. CPC H02G 1/02; H02G 7/125

(57) ABSTRACT

Apparatuses and methods for removing line spacers from wires such as electrical power transmission wires, guy wires, and the like are disclosed. The apparatuses include robotic devices that convey along the wires and cut the line spacers therefrom with reciprocating blade cutting mechanisms.

### CROSS-REFERENCE TO RELATED APPLICATIONS

This application claims priority of U.S. provisional patent application Ser. No. 63/554,056, filed Feb. 15, 2024, which is incorporated by reference into this application in its entirety.

### TECHNICAL FIELD

The present disclosure is related to the field of apparatuses and methods for removing line spacers from wires such as electrical power transmission wires, guy wires, and the like, in particular, robotic apparatuses for conveying along the wires and cutting the line spacers therefrom.

### BACKGROUND

As known to those skilled in the art, overhead power transmission lines are often constructed with dual bundle conductors, such that each conductor bundle consists of two conductors. The two cables of each conductor bundle are spaced relatively close together, thus require spacers to be fitted that control the motion of the two conductors relative to each other, such that they do not impact together when moved by wind or other environmental effects. As the spacers age, they may need to be replaced.

Currently, workers in spacer buggies will sometimes traverse the powerline and remove the spacers by hand. Another possible method involves setting up a bucket truck at every spacer and a worker riding the basket up and removing each spacer manually. A helicopter slinging a worker in on a longline may also be employed. These are just examples of current methods and other methods may exist, but in general, the existing methods are time consuming, dangerous, and relatively expensive.

It is, therefore, desirable to provide a system and method for removing line spacers that is time efficient, safe, and inexpensive.

### SUMMARY

Apparatuses and methods are provided for removing line spacers from wires such as such as electrical power transmission wires, guy wires, and the like. The apparatuses can comprise a robotic device configured for conveying along the wires and cutting the line spacers therefrom with cutting modules disposed on the robotic device.

In some embodiments, the robotic device can be placed on the wires and traverse or convey along the wires with buggy wheel assemblies with electric motors disposed therein. The robotic device can convey along the wires until it reaches a line spacer to be removed, move the cutting modules to cut the line spacer until it falls off of the wires. In some embodiments, the cutting modules can comprise reciprocating blade mechanism for cutting the line spacers.

Broadly stated, in some embodiments, an apparatus can be provided for removing a line spacer from a plurality of wires, the apparatus comprising: a body assembly comprising a front side and a rear side, and further comprising a pair of adjacent sides disposed between the front side and the rear side, the body assembly comprising a plurality of support tubes extending from the front side, the body assembly further comprising at least one cross bar disposed between the plurality of support tubes; a plurality of buggy wheel assemblies disposed on the body assembly, the buggy wheel assemblies configured for placement on the plurality of wires and for conveying the apparatus along the plurality of wires; and a spacer removal assembly disposed on at least one cross bar, the spacer removal assembly configured for cutting the line spacer from the plurality of wires.

Broadly stated, in some embodiments, the plurality of buggy wheel assemblies can comprise a first set of the plurality of buggy wheel assemblies disposed near the front side of the body assembly and a second set of the plurality of buggy wheel assemblies disposed near the rear side of the body assembly.

Broadly stated, in some embodiments, each of the plurality of buggy wheel assemblies can comprise: a top wheel for resting on top of one of the plurality of wires; a retractor wheel disposed beneath the one of the plurality of wires when the apparatus is placed on the plurality wires; and an actuator for retracting and extending the retractor wheel towards and away from the one of the plurality of wires, wherein retracting the retractor wheel into contact with the one of the plurality of wires and rotation of the top wheel conveys the apparatus along the plurality of wires.

Broadly stated, in some embodiments, the top wheel can comprise an electric motor disposed therein for rotating the top wheel.

Broadly stated, in some embodiments, the spacer removal assembly can comprise at least one pair of cutting modules rotatably attached to the at least one cross bar.

Broadly stated, in some embodiments, each of the at least one pair of cutting modules can comprise a reciprocating blade for cutting the line spacer when the at least one pair of cutting modules are rotated on the at least one cross bar towards the line spacer.

Broadly stated, in some embodiments, the spacer removal assembly can comprise a rocker arm rotatably coupled to the at least one cross bar, the rocker arm rotatable about an axis orthogonal to the plurality of wires, the rocker arm operatively coupled to two of the at least one pair of cutting modules via connecting linkage connected thereto wherein rotation of the rocker arm rotates the at least one pair of cutting modules on the at least one cross bar towards and away from the line spacer.

Broadly stated, in some embodiments, each of the at least one pair of cutting modules can comprise a pivot assembly for rotating the reciprocating blade about a longitudinal axis of the reciprocating blade.

Broadly stated, in some embodiments, the pivot assembly can comprises: a pivot mount rotatably disposed on the at least one cross bar; a pinion gear rotatably coupled to a pinion gear servo disposed on the pivot mount; and a ring gear disposed on each of the at least one pair of cutting modules, the pinion gear engaged with the ring gear wherein rotation of the pinion gear rotates each of the at least one pair of cutting modules.

Broadly stated, in some embodiments, a method can be provided for removing a line spacer from a plurality of wires, the method comprising: placing an apparatus on the plurality of wires, the apparatus comprising: a body assembly comprising a front side and a rear side, and further comprising a pair of adjacent sides disposed between the front side and the rear side, the body assembly comprising a plurality of support tubes extending from the front side, the body assembly further comprising at least one cross bar disposed between the plurality of support tubes, a plurality of buggy wheel assemblies disposed on the body assembly, the buggy wheel assemblies configured for placement on the plurality of wires and for conveying the apparatus along the plurality of wires, and a spacer removal assembly disposed on at least one cross bar, the spacer removal assembly configured for cutting the line spacer from the plurality of wires; conveying the apparatus on the plurality of wires towards the line spacer; and cutting the line spacer from the plurality of wires.

Broadly stated, in some embodiments, the line spacer comprises one of a single bolt spacer, a spring spacer, a Dulmison® spacer, and a quad spacer.

### BRIEF DESCRIPTION OF THE DRAWINGS

FIG. 1 is an overhead perspective view depicting 3 configurations of line spacers on a dual conductor bundle of an overhead transmission line.

FIG. 2 is a perspective view depicting a quad line spacer on a quad conductor bundle.

FIG. 3 is a perspective view depicting one embodiment of a spacer removal robot with wheels retracted.

FIG. 4 is a front view depicting the spacer removal robot of FIG. 3.

FIG. 5 is a perspective view depicting the spacer removal robot of FIG. 3 on a pair of transmission lines, with the wheels retracted.

FIG. 6 is a perspective view depicting the spacer removal robot of FIG. 5, with the wheels extended.

FIG. 7 is a perspective view depicting the spacer removal robot of FIG. 5, with the wheels clamped onto the pair of transmission lines.

FIG. 8 is a side elevation view depicting the spacer removal robot of FIG. 7, advancing towards to a spacer mounted on the pair of transmission lines.

FIG. 9 is a side elevation view depicting a first configuration of the spacer removal robot of FIG. 8, with a pair of cutting modules preparing to cut the spacer from the pair of transmission lines.

FIG. 10 is a front elevation view depicting the spacer removal robot of FIG. 9, with the cutting modules completing the cutting of the spacer.

FIG. 11 is a front elevation view depicting the cut spacer of FIG. 10 falling into a bucket.

FIG. 12 is a perspective view depicting the spacer removal robot of FIG. 9 with the cutting modules in a rotated position.

FIG. 13 is a side elevation view depicting a second configuration of the spacer removal robot of FIG. 9, with a pair of cutting modules preparing to cut the spacer from the pair of transmission lines.

FIG. 14 is a front elevation view depicting the spacer removal robot of FIG. 13, with the cutting modules completing the cutting of the spacer.

FIG. 15 is a front elevation view depicting the cut spacer of FIG. 14 falling into a bucket.

FIG. 16 is a perspective view depicting one embodiment of a cutting module of FIG. 9.

FIG. 17 is a perspective cut-away view depicting the cutting module of FIG. 16 rotating.

FIG. 18 is a top plan view depicting the cutting modules of FIG. 9, the cutting modules coupled together with a servo linkage mechanism.

FIG. 19 is a perspective view depicting a second embodiment of the spacer removal robot mounted on a pair of transmission lines prior to cutting a spring-type spacer from the transmission lines.

FIG. 20 is a side elevation view depicting the spacer removal robot of FIG. 19, advancing towards to the spring spacer.

FIG. 21 is a side elevation view depicting the spacer removal robot of FIG. 20, with a pair of cutting modules preparing to cut the spring spacer from the pair of transmission lines.

FIG. 22 is a perspective view depicting the spacer removal robot of FIG. 21, with the cutting modules completing the cutting of the spring spacer.

FIG. 23 is a front elevation view depicting the cut spring spacer of FIG. 22 falling into a bucket.

FIG. 24 is a perspective view depicting one embodiment of a cutting module of FIG. 21.

FIG. 25 is a top plan view depicting the cutting modules of FIG. 21, the cutting modules coupled together with a servo linkage mechanism.

FIG. 26 is a side elevation view depicting a first configuration of the spacer removal robot of FIG. 21, with a pair of cutting modules preparing to cut a Dulmison® spacer from the pair of transmission lines.

FIG. 27 is a perspective view depicting the spacer removal robot of FIG. 26, with the cutting modules completing the cutting of the Dulmison® spacer.

FIG. 28 is a front elevation depicting the cut Dulmison® spacer of FIG. 27 falling into a bucket.

FIG. 29 is a perspective view depicting a third embodiment of a spacer removal robot for removing spacers from a quad set of transmission lines.

FIG. 30 is a rear elevation view depicting the spacer removal robot of FIG. 29.

FIG. 31 is a top plan view depicting the spacer removal robot of FIG. 29 with a pair of cutting modules prior to retracting inwards to the robot.

FIG. 32 is a top plan view depicting the spacer removal robot of FIG. 31 with the pair of cutting modules in a retracted position to fit within the quad set of transmission lines.

FIG. 33 is a perspective view depicting the spacer robot of FIG. 31 with the wheels in a retracted position.

FIG. 34 is a perspective view depicting the spacer robot of FIG. 31 with the wheels in an extended position.

FIG. 35 is a perspective view depicting the spacer robot of FIG. 31 with the wheels clamped on the quad set of transmission lines.

FIG. 36 is a side elevation view depicting the spacer removal robot of FIG. 31, advancing towards to a spacer mounted on the quad set of transmission lines.

FIG. 37 is a side elevation view depicting the spacer removal robot of FIG. 36, with a set of 4 cutting modules preparing to cut the spacer from the quad set of transmission lines.

FIG. 38 is a perspective view depicting the spacer removal robot of FIG. 37, with the cutting modules completing the cutting of the spacer from the quad set of transmission lines.

FIG. 39 is a front elevation view depicting the cut spacer of FIG. 38 falling into a bucket.

### DETAILED DESCRIPTION OF EMBODIMENTS

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments but is not necessarily included. Thus, the present technology can include a variety of combinations and/or integrations of the embodiments described herein.

The presently disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All references to singular characteristics or limitations of the present disclosure shall include the corresponding plural characteristic(s) or limitation(s) and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

While the following terms used herein are believed to be well understood by one of ordinary skill in the art, definitions are set forth to facilitate explanation of the presently disclosed subject matter.

Unless defined otherwise, all technical and scientific terms used herein have the same meaning as commonly understood by one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in this application, including the claims.

Unless otherwise indicated, all numbers expressing quantities, properties, and so forth used in the specification and claims are to be understood as being modified in all instances by the term “about”. Accordingly, unless indicated to the contrary, the numerical parameters set forth in this specification and claims are approximations that can vary depending upon the desired properties sought to be obtained by the presently disclosed subject matter.

As used herein, the term “about”, when referring to a value or to an amount of mass, weight, time, volume, concentration or percentage is meant to encompass variations of in some embodiments +/−50%, in some embodiments +/−40%, in some embodiments +/−30%, in some embodiments +/−20%, in some embodiments +/−10%, in some embodiments +/−5%, in some embodiments +/−1%, in some embodiments +/−0.5%, and in some embodiments +/−0.1% from the specified amount, as such variations are appropriate to perform the disclosed method.

Alternatively, the terms “about” or “approximately” can mean within an acceptable error range for the particular value as determined by one of ordinary skill in the art, which will depend in part on how the value is measured or determined, i.e., the limitations of the measurement system. For example, “about” can mean within 3, or more than 3, standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently disclosed subject matter.

As used herein, ranges can be expressed as from “about” one particular value, and/or to “about” another particular value. It is also understood that there are a number of values disclosed herein, and that cach value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

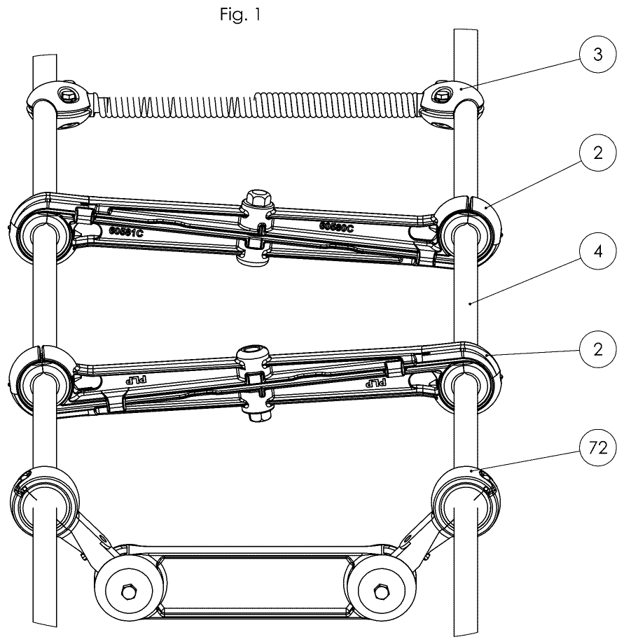

Referring to FIG. 1, illustrated are three different powerline spacers that can be removed by the line spacer removal robot [1]. Two possible orientations of single bolt spacer [2] as manufactured by Preformed Line Products of Cleveland, Ohio, USA and AFL of Duncan, South Carolina, USA as well as the only possible orientations of spring spacer [3] as manufactured by AFL of Duncan, South Carolina, USA and Dulmison® dual spacer [72] as manufactured by Preformed Line Products of Cleveland, Ohio, USA are shown attached to a set of dual wires [4]. The purpose of each powerline spacer is the same and is known by those skilled in the art. As a result of the two orientations of the single bolt spacer [2] and one orientation of both the spring spacer [3] and Dulmison® dual spacer [72], line spacer removal robot [1] can comprise have four different embodiments or configurations to remove any of these three line spacers in any orientation that they may appear.

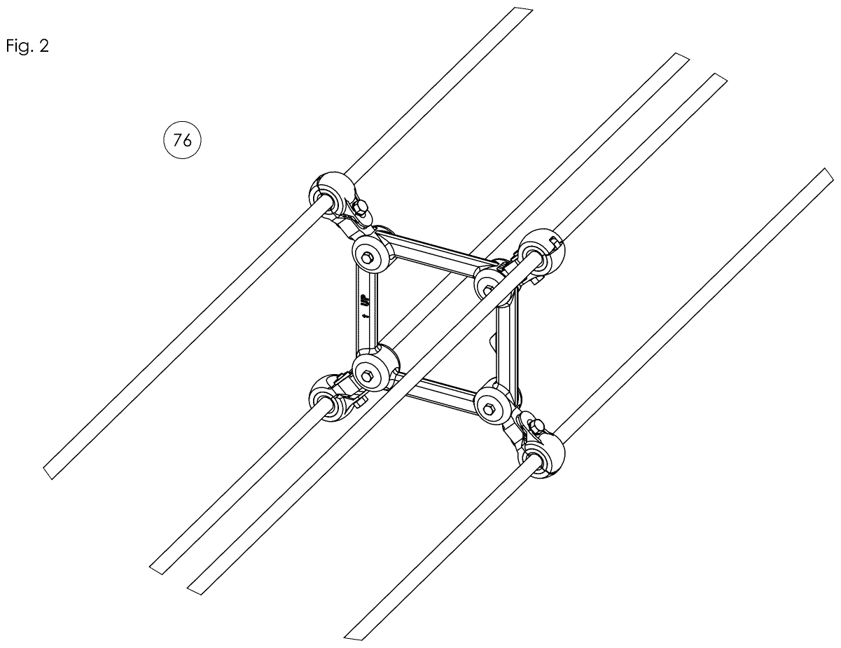

Referring to FIG. 2, a perspective view of a quadruple powerline spacer that can be removed by quad spacer removal robot [75]. The purpose of the quad spacer [76] is the same as that of any of the above dual powerline spacers and is known by those skilled in the art.

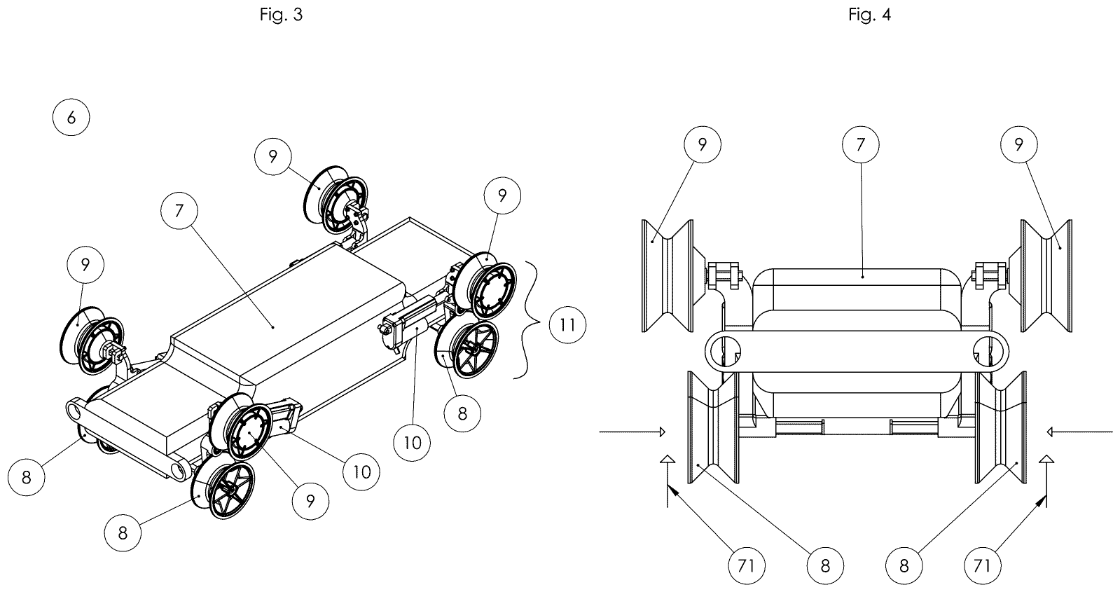

Referring to FIGS. 3 and 4, illustrated are the initial steps of putting line spacer removal robot [1] on a set of dual wires [4]. In some embodiments, line spacer removal robot [1] can be installed with a worker using a bucket truck or crane man-basket to elevate line spacer removal robot [1] and the worker to the conductor bundles as well known to those skilled in the art. In these figures, spacer removal assembly [5] is hidden for clarity. FIG. 3 shows an isometric view of the contents of robot body assembly [6]. In some embodiments, robot body assembly [6] can comprise of robot body [7], and a plurality of buggy wheel assembly [11], each of which contain a retractor wheel [8], top wheel [9] and actuator [10]. FIG. 3 shows the retracted state of each of retractor wheels [8]. The plurality of retractor wheels [8] can be positioned in the retracted state for ease of placement onto a set of dual wires [4]. Retractor wheels [8] can fit inside of dual wires [4] and line spacer removal robot [1] can be lowered down until top wheels [9] meet and rest upon dual wires [4]. As line spacer removal robot [1] is lowered down, the dual wires [4] will follow the path shown by arrow [71] until contact is made with top wheels [9].

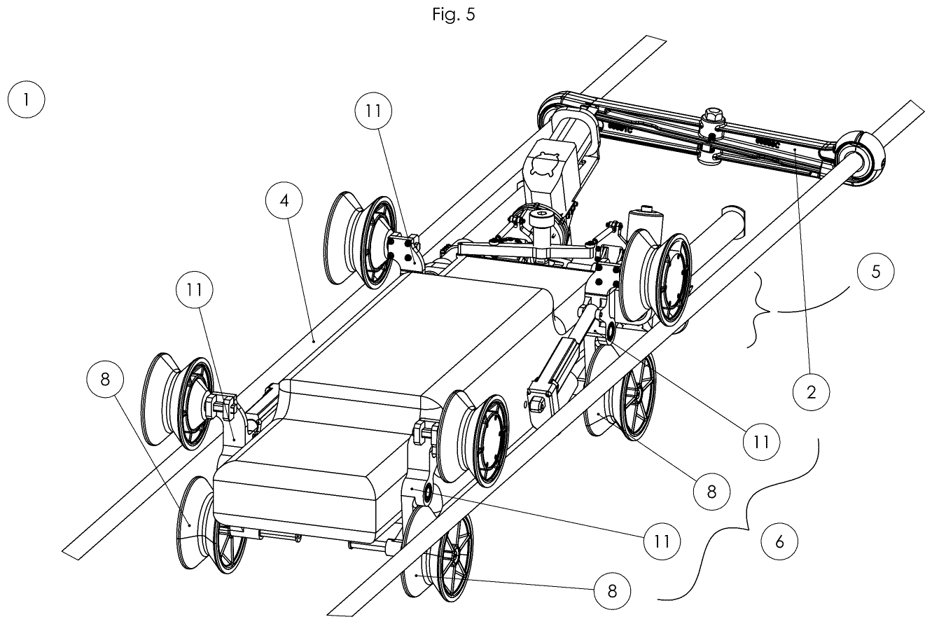

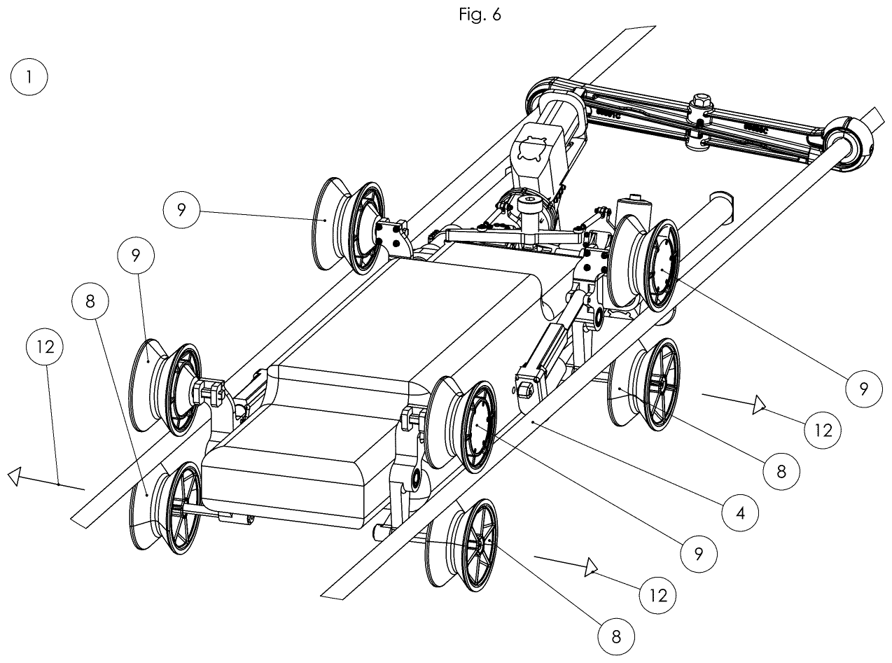

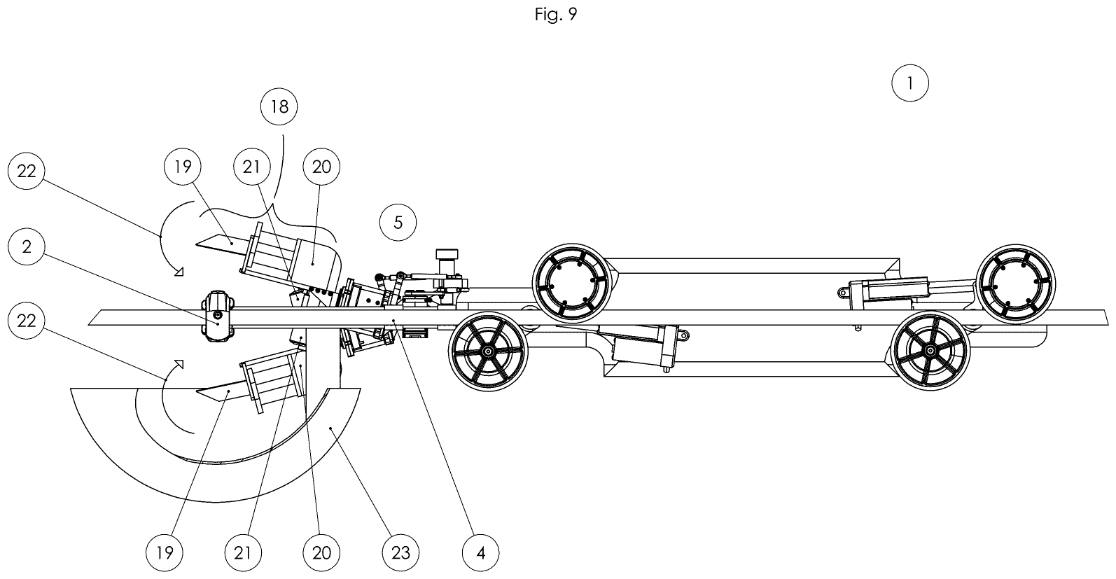

Referring to FIG. 5, a perspective view is provided of the entirety of line spacer removal robot [1] placed on a set of dual wires [4] with retractor wheels [8] still retracted. In some embodiments, line spacer removal robot [1] can comprise two main assemblies, those being: robot body assembly [6] and spacer removal assembly [5]. See FIG. 9 for a detailed view of spacer removal assembly [5]. In some embodiments, spacer removal assembly [5] can comprise of a plurality of spacer cutting module [18], bucket [23] (hidden in this figure for clarity), and a plurality of linkages and servo motors discussed in later figures. In some embodiments, the plurality of buggy wheel assembly [11] can be configured in the open state and line spacer removal robot [1] can be positioned at a distance from single bolt spacer [2], which can be clamped between dual wires [4] in one of the two possible orientations. FIG. 6 shows the same perspective view as shown in FIG. 5, but with retractor wheels [8] in the extended position. In some embodiments, retractor wheels [8] can extend in the direction of retractor wheel arrow [12] until they become flush with top wheels [9]. In some embodiments, retractor wheels [8] can be extended manually or can be fitted with suitable actuators to enable electronics inside line spacer removal robot [1] to extend the wheels when commanded wirelessly. Once line spacer removal robot [1] has reached this position, a full connection can be established with dual wires [4].

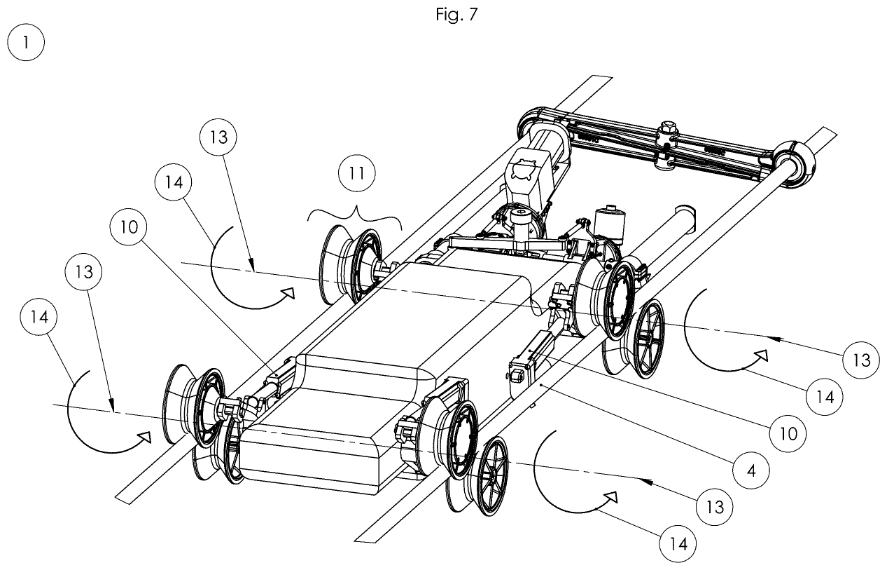

Referring to FIG. 7, a perspective view of line spacer removal robot [1] with a fully established connection to dual wires [4]. This connection can be established through the rotation of the plurality of buggy wheel assembly [11], driven by the respective actuators [10] to clamp down on the dual wires [4]. In some embodiments, the plurality of buggy wheel assembly [11] can rotate about buggy wheel axis [13] in the direction of buggy wheel arrow [14] until a sufficient torque is reached that will maintain a solid connection between dual wires [4] and line spacer removal robot [1]. In some embodiments, each actuator [10] can be driven by internally located electronics hidden by robot body [7]. In some embodiments, actuators [10] can be commanded wirelessly by an operator over a radio communication link.

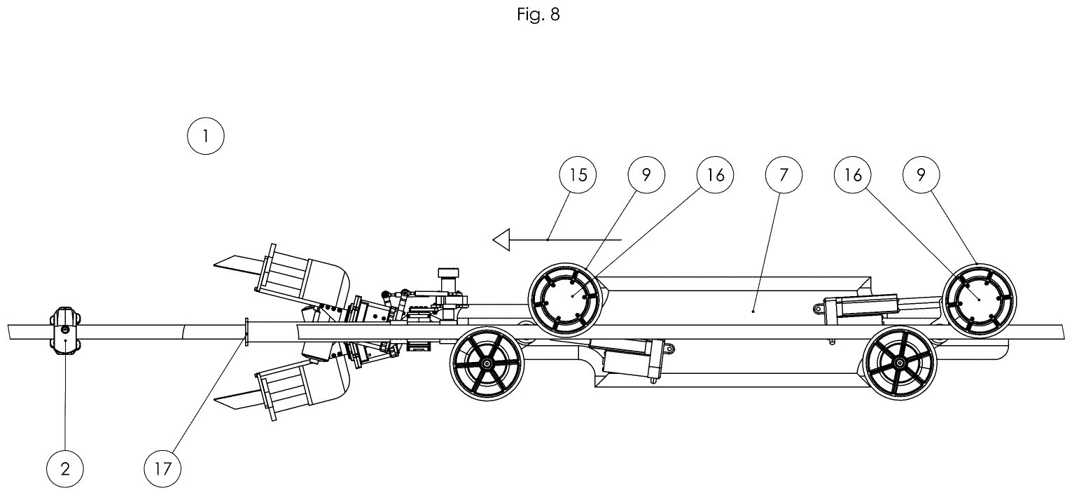

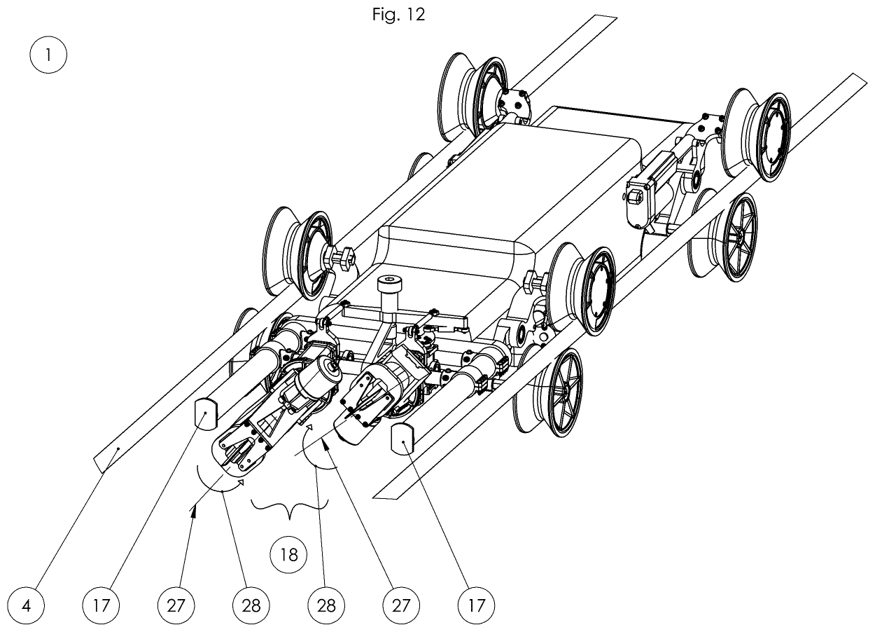

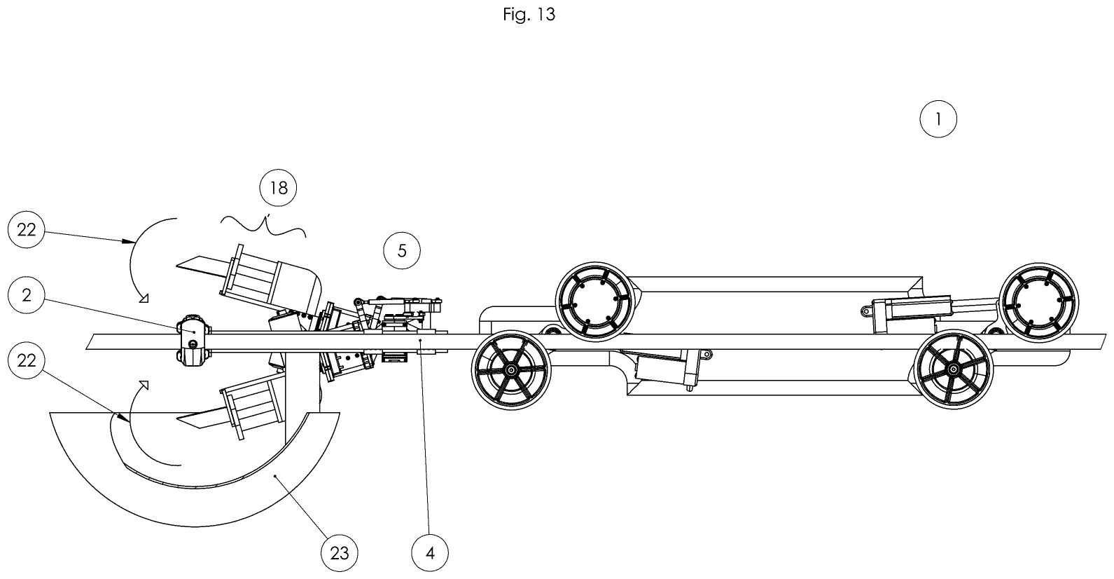

Referring to FIG. 8, illustrated is a side view of line spacer removal robot [1] driving on the dual wire [4] along travel arrow [15] towards single bolt spacer [2] in one of its two possible orientations. This motion can be achieved by multiple motors [16] set inside a plurality of top wheels [9]. Each motor [16] can be driven by internally located electronics hidden by robot body [7] and, in some embodiments, can be commanded wirelessly by an operator. In some embodiments, line spacer removal robot [1] can be advanced in the direction of travel arrow [15] until bump stops [17] comes into contact with single bolt spacer [2]. Bump stops [17] can be more clearly seen in FIG. 12.

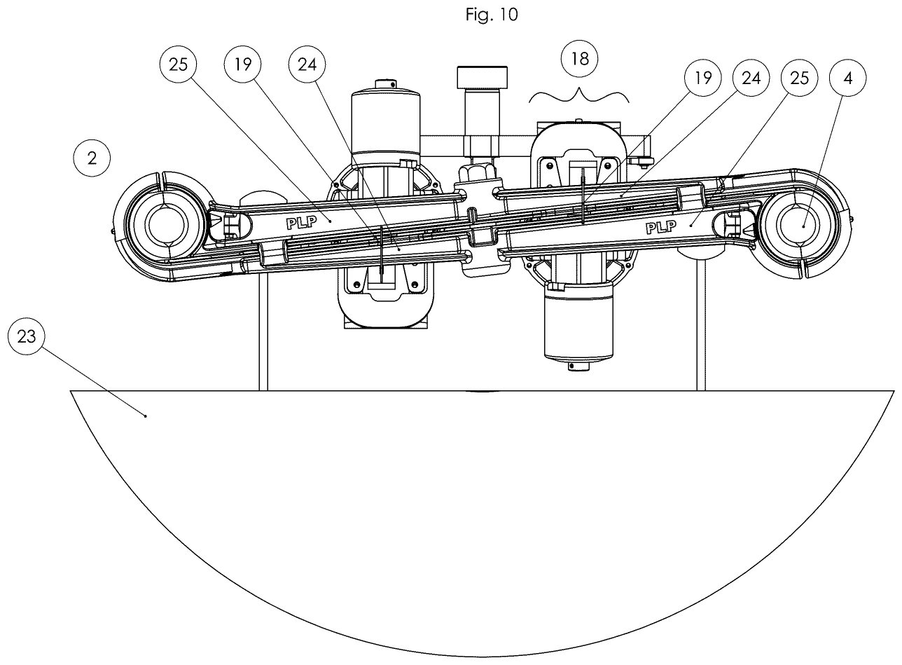

Referring to FIG. 9, illustrated is a side view of line spacer removal robot [1] as well as a plurality of spacer cutting module [18], which can comprise of blade [19], reciprocating gearbox [20], and motor [21]. In some embodiments, the plurality of spacer cutting module [18] can rotate along cutting arrow [22] to cut and remove single bolt spacer [2], as shown in one of its two possible orientations. In some embodiments, attached to spacer removal assembly [5] can be bucket [23] for the purpose of catching single bolt spacer [2] as it falls off of dual wire [4] after being cut. As shown in FIG. 10, the cutting motion taken along cutting arrow [22] can continue until the plurality of blades [19] cut through the respective tensile members [24] that are loaded in tension single bolt spacer [2], as known to those skilled in the art. The tensile member [24] can be determined by the operator who can wirelessly configure line spacer removal robot [1] and the plurality of spacer cutting module [18] to ensure the correct member is cut by the blade [19]. Once each tensile member [4] is cut, single bolt spacer [2] is no longer bound and will fall off of dual wire [4] into bucket [23]. The compressive members [25] that are loaded in compression, as known to those skilled in the art, can aid in this process by pushing apart single bolt spacer [2] until it is no longer on dual wire [4].

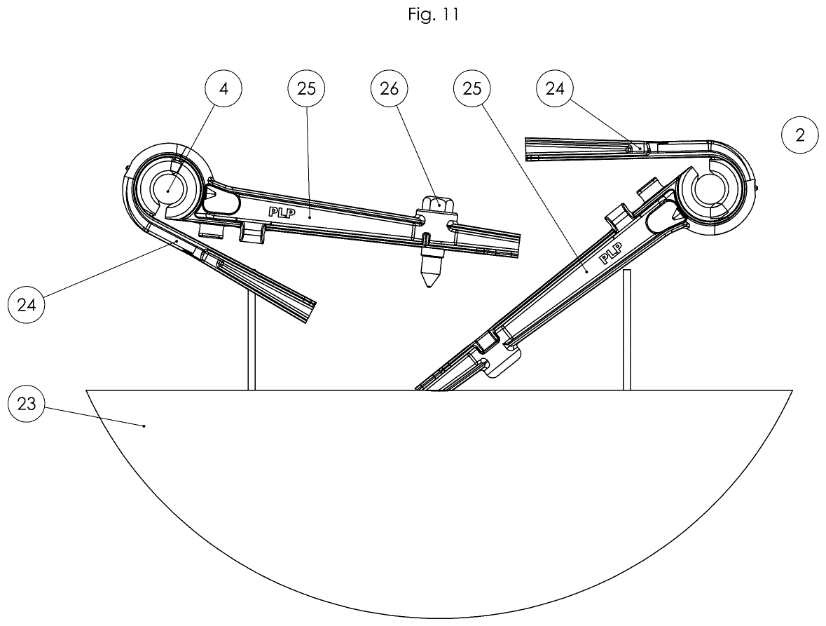

Referring to FIG. 11, illustrated is a clear view of single bolt spacer [2], which can comprise of bolt [26] as well as each tensile member [24] and compressive member [25], falling off of dual wire [4] and into bucket [23]. In this figure, line spacer removal robot [1] and its components are not shown for clarity.

Referring to FIG. 12, illustrated is a perspective view of line spacer removal robot [1] on dual wires [4] with single bolt spacer [2] not shown for clarity. This figure shows the process of rotating spacer cutting modules [18] about rotation axis [27] in the direction of rotation arrow [28]. Having this rotation allows the spacer cutting modules [18] to be wirelessly configured by an operator to the correct orientation to ensure that tensile members [24] of single bolt spacer [2] are cut, no matter which of the two orientations of single bolt spacer [2] are present.

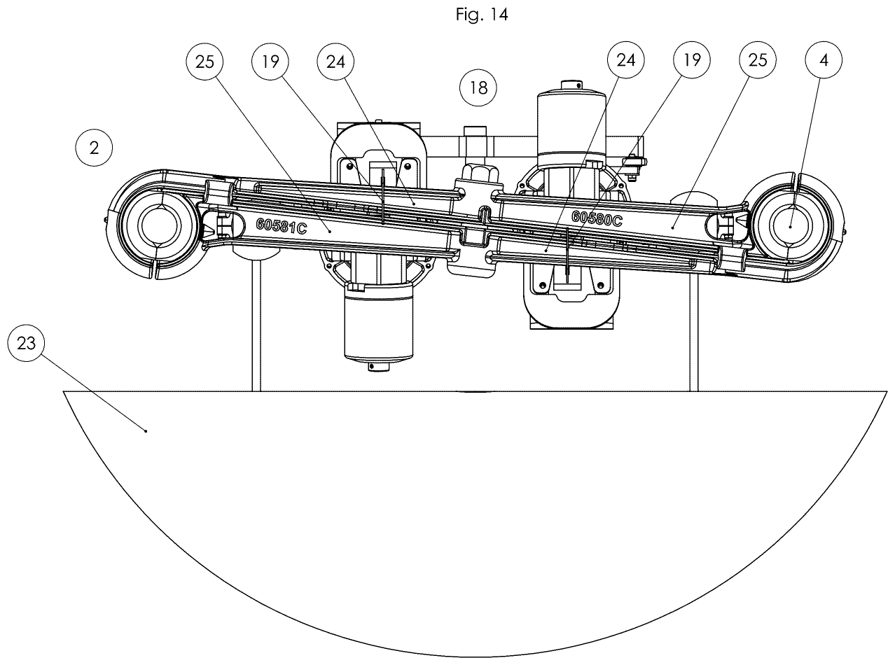

Referring to FIG. 13, illustrated is a side view of line spacer removal robot [1] as well as a plurality of spacer cutting modules [18] configured to remove single bolt spacer [2] in the second possible orientation or configuration. Once line spacer removal robot [1] is in the correct configuration, the process of removing single bolt spacer [2] is the same as outlined for the first orientation. The plurality of spacer cutting modules [18] can rotate along cutting arrow [22] to cut and remove single bolt spacer [2]. In some embodiments, attached to spacer removal assembly [5] is bucket [23] for the purpose of catching single bolt spacer [2] as it falls off dual wire [4]. As outlined in FIG. 14, the cutting motion taken along cutting arrow [22] can continue until the plurality of blades [19] cut through the respective tensile members [24] of single bolt spacer [2]. Tensile member [24] is determined by the operator who will configure line spacer removal robot [1] and the plurality of spacer cutting module [18] to ensure the correct member is cut by blades [19]. Once tensile members [24] are cut, single bolt spacer [2] is no longer bound and is free to fall off dual wire [4] and into bucket [23]. Compressive members [25] can aid in this process by pushing apart single bolt spacer [2] until it is no longer on dual wire [4].

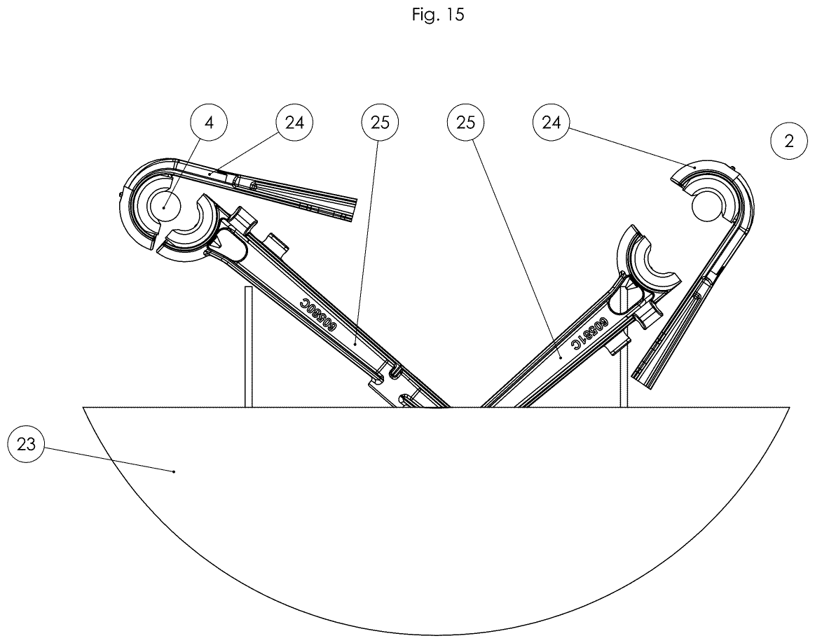

Referring to FIG. 15, illustrated is a clear view of single bolt spacer [2] comprising of bolt [26] which is not shown in this view by bucket [23], as well as each tensile member [24] and compressive member [25] falling off dual wire [4] and into bucket [23]. In this figure, single bolt spacer [2] is cut and shown in its second possible orientation, and line spacer removal robot [1] and its components are not shown for clarity.

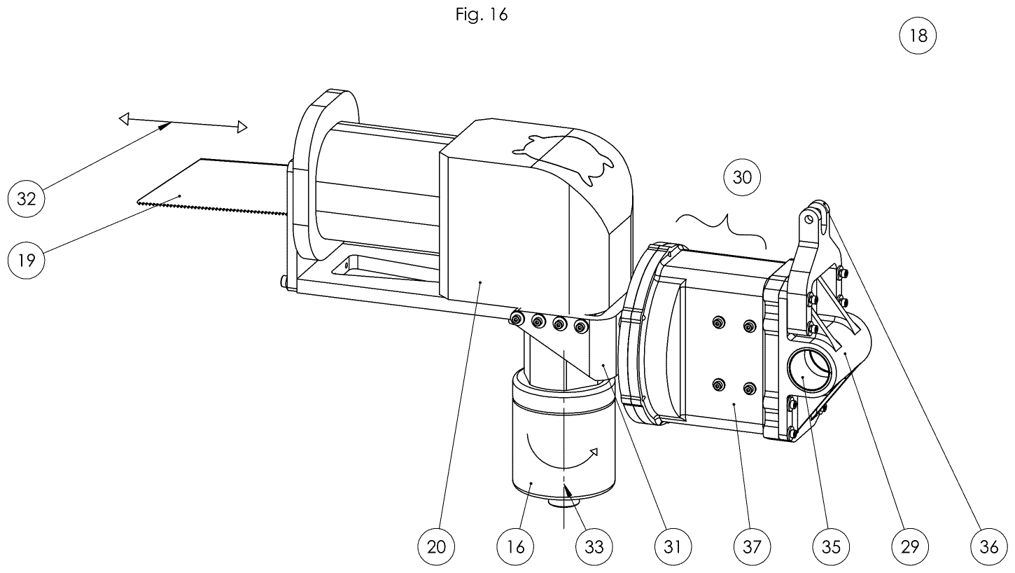

Referring to FIG. 16, illustrated is a perspective view of spacer cutting module [18] that can comprise of pivot mount [29] mechanically coupled to pivot assembly [30] the output of which can be mechanically coupled to cutter support [31] to which reciprocating gearbox [20] can be mechanically secured to. In some embodiments, the linear motion of blade [19] along linear arrow [32] can be substantially coupled to the rotary motion of motor [21] about axis [33] through reciprocating gearbox [20], as known by those skilled in the art. In some embodiment, the speed of blade [19] can be directly proportional to the rotation speed of motor [21] which can be commanded by computer [34]. In some embodiments, pivot mount [29] can comprise two of bushing [35], which can permit rotation but not radial translation, and of pivot point [36].

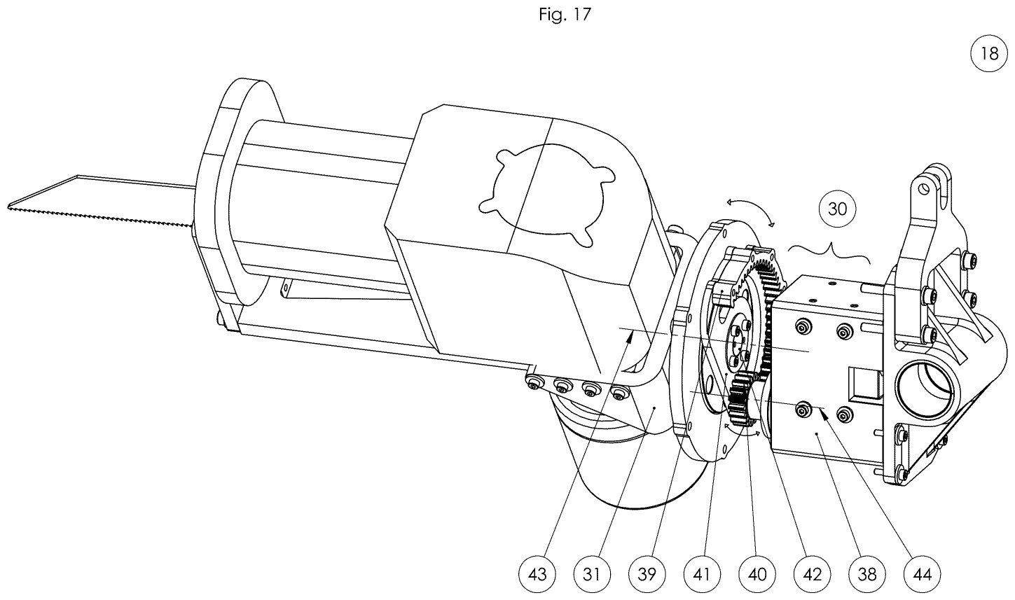

Referring to FIG. 17, illustrated is a perspective view of spacer cutting module [18] with pivot housing [37] not shown to show the internal design of pivot assembly [30]. In some embodiments, pivot assembly [30] can comprise of pivot servo [38], ring gear [39], pinion gear [40], support bearing [41], and output shaft [42]. In some embodiments, output shaft [42] can be mechanically connected to cutter support [31]. In some embodiments, output shaft [42] can be supported by support bearing [41] of which the internal crossed roller construction can allow rotation solely about output axis [43], as known by those skilled in the art. In some embodiments, output shaft [42] can be mechanically coupled to ring gear [39]. Pinion gear [40] can mesh with ring gear [39] such that ring gear [39] can rotate with a specific ratio relative to pinion gear [40] rotation about axis [44], as known by those skilled in the art. In some embodiments, pinion gear [40] can be mechanically coupled to the output of pivot servo [38] such that rotation of pivot servo [38] output can cause a rotation of cutter support [31] as commanded by computer [34].

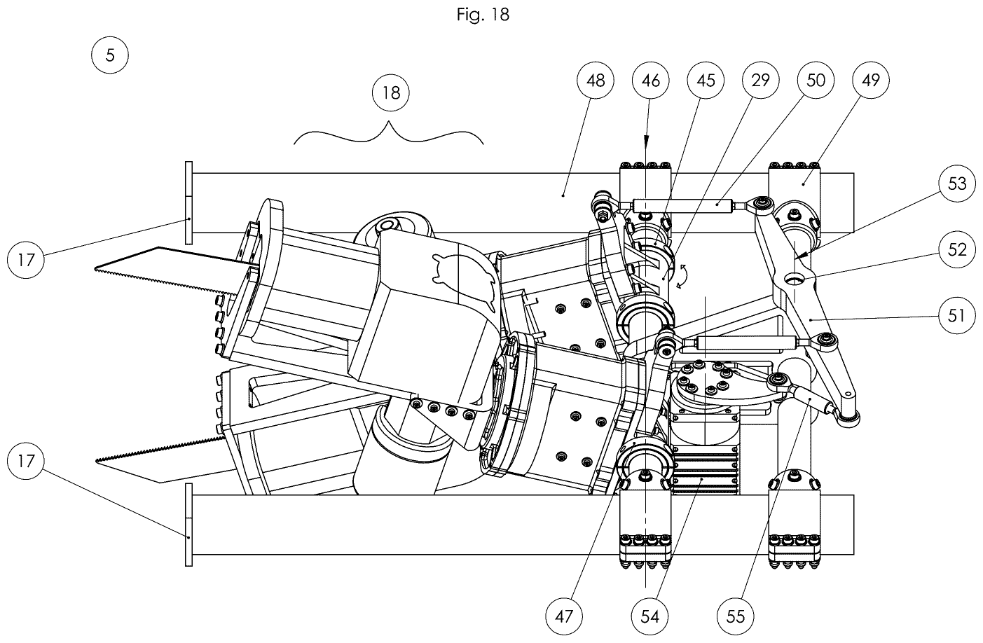

Referring to FIG. 18, illustrated is a perspective view of spacer removal assembly [5]. In some embodiments, spacer removal assembly [5] can comprise of two spacer cutting module [18] pivotally supported about their respective pivot mount [29] on cross bar [45] thereby allowing rotation about axis [46] and can be constrained axially by clamps [47]. In some embodiments, cross bar [45] can be structurally mounted to the support tubes [48] by frame clamps [49]. The rotation of each spacer cutting module [18] about axis [46] can be driven by connecting linkage [50] that can translate the motion of rocker arm [51]. In some embodiments, the rotation of the two spacer cutting modules [18] can be synchronized by rocker arm [51] such that spacer cutting modules [18] move in opposing directions. In some embodiments, rocker arm [51] can be pivotally supported by rocker arm bearing [52] allowing rotation about axis [53]. The rotation of rocker arm [51] about axis [53] can be controlled by rocker arm servo [54] through servo linkage [55]. In some embodiments, rocker arm servo [54] can be commanded to a position in which spacer cutting modules [18] are not obstructing single bolt spacer [2] allowing single bolt spacer [2] to enter the device and reach the plurality of bump stops [17]. Once single bolt spacer [2] is in place, rocker arm servo [54] can be commanded to move spacer cutting module [18] about axis [46] such that blades [19] cut through single bolt spacer [2] during the cutting operation as described previously.

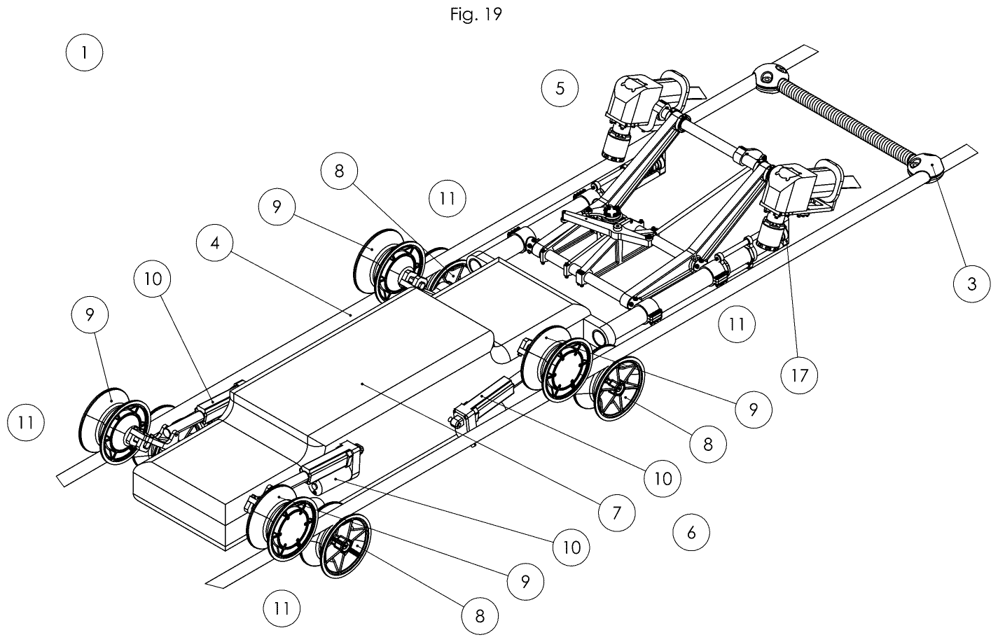

Referring to FIG. 19, illustrated is a perspective view of line spacer removal robot [1] on a set of dual wires [4] configured to remove a spring spacer [3]. The process of placing line spacer removal robot [1] on dual wires [4] is the same as described above for single bolt spacer [2]. In some embodiments, robot body assembly [6] can be the same between single bolt spacer [2] and spring spacer [3] configurations, and comprise of robot body [7], and a plurality of buggy wheel assembly [11] wherein each can comprise retractor wheels [8], top wheels [9], and actuators [10]. In some embodiments, spacer remover assembly [5] can comprise of many of the same components with a few key differences that will be outlined in later figures. In this figure, a secure connection has already been established between line spacer removal robot [1] and dual wires [4] at a distance from spring spacer [3].

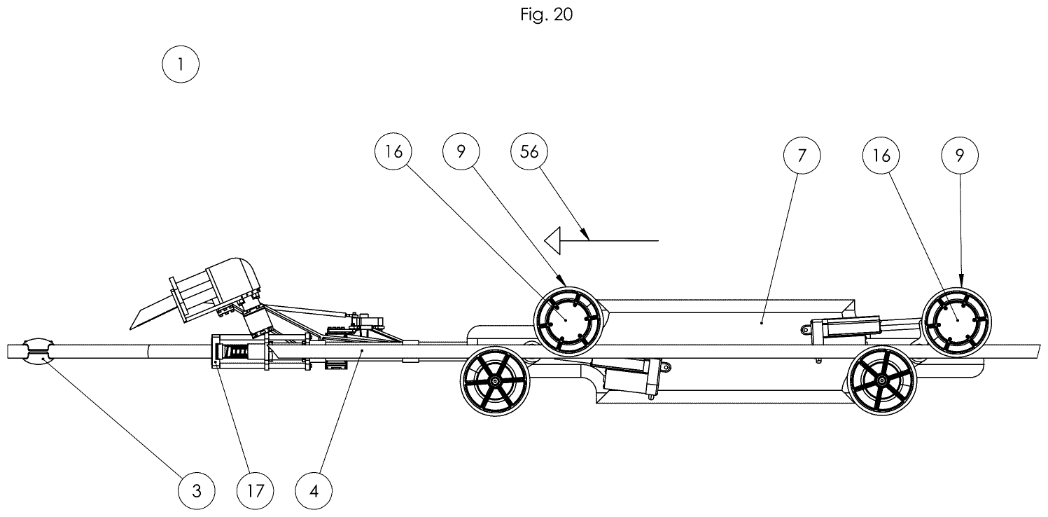

Referring to FIG. 20, illustrated is a side view of line spacer removal robot [1] driving on dual wire [4] along travel arrow [56] towards spring spacer [3]. This motion can be achieved by multiple motors [16] set inside a plurality of top wheels [9]. Each motor [16] can be driven by internally located electronics, hidden by robot body [7] in this figure, and can be commanded wirelessly by an operator. In some embodiments, line spacer removal robot [1] can advance in the direction of travel arrow [56] until bump stops [17] come into contact with spring spacer [3].

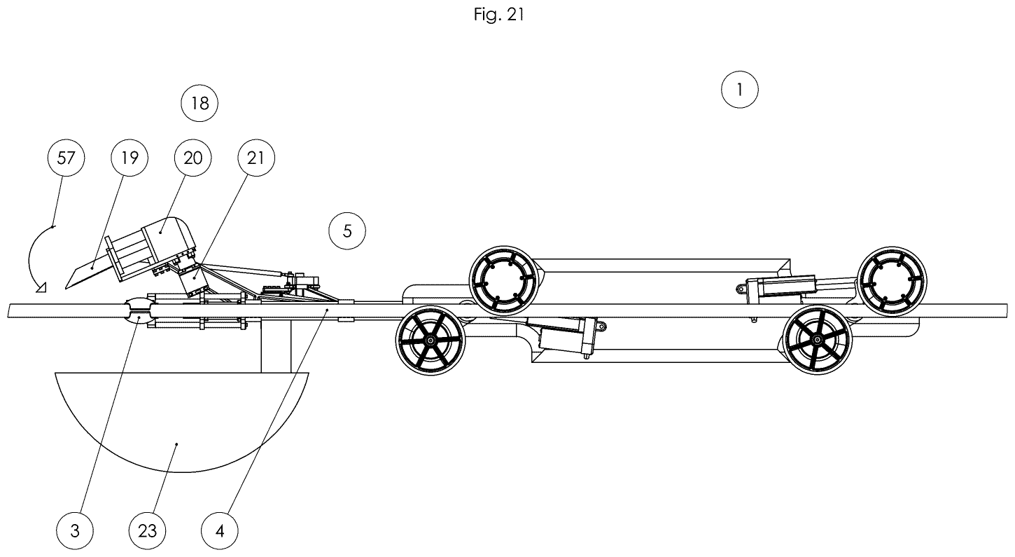

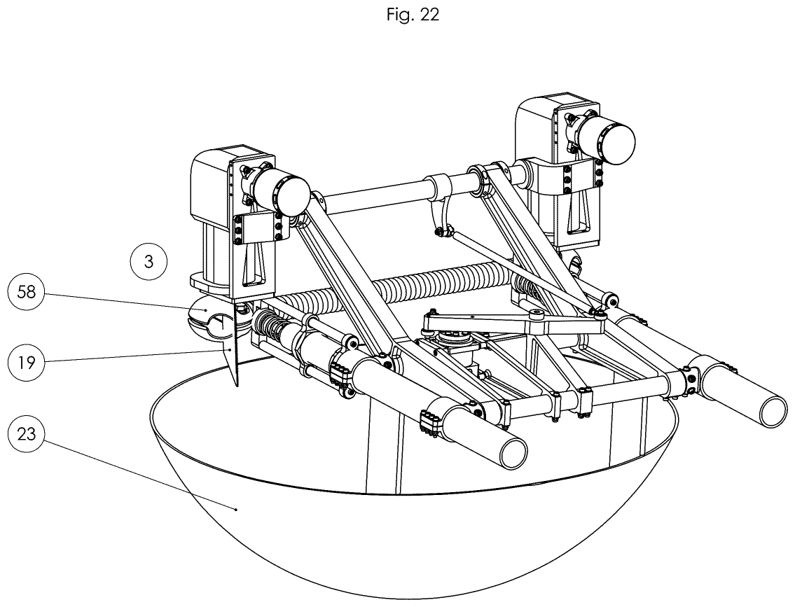

Referring to FIG. 21, illustrated is a side view of line spacer removal robot [1] as well as a plurality of spacer cutting module [18], which can comprise of blade [19], reciprocating gearbox [20], and motor [21]. In some embodiments, the plurality of spacer cutting module [18] can rotate along cutting arrow [57] to cut and remove spring spacer [3]. When line spacer removal robot [1] is positioned to remove one or more spring spacers [3], spacer cutting module [18] can rotate synchronously, as compared to the opposing rotation found when line spacer removal robot [1] is configured to remove single bolt spacer [2]. In some embodiments, attached to spacer removal assembly [5] is a bucket [23] for the purpose of catching spring spacer [3] as it falls off of dual wire [4]. As shown in FIG. 22, the cutting motion taken along cutting arrow [57] can continue until the plurality of blades [19] cut through the plurality of spacer clamps [58] located on either side of spring spacer [3]. In FIG. 21, dual wires [4] are not shown for clarity. Once both spacer clamps [58] are cut, spring spacer [3] is no longer attached to dual wire [4] and can fall into bucket [23].

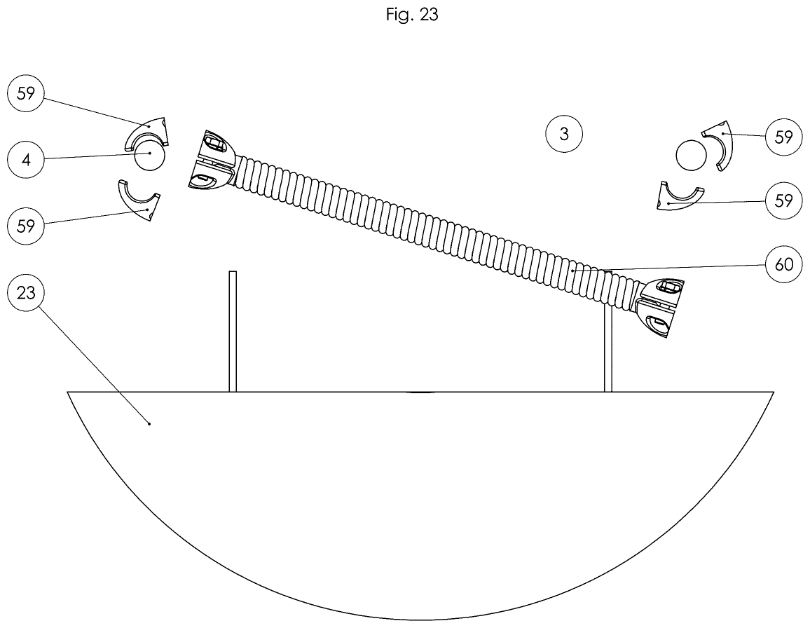

Referring to FIG. 23, illustrated is a clear view of spring spacer [3] after it has been cut by the plurality of spacer cutting modules [18] and is falling into bucket [23]. Upon Removal from dual wires [4], spring spacer [3] comprises of multiple pieces, including a plurality of spacer clamp halves [59] and spring spacer member [60]. In this figure, line spacer removal robot [1] and its components are not shown for clarity.

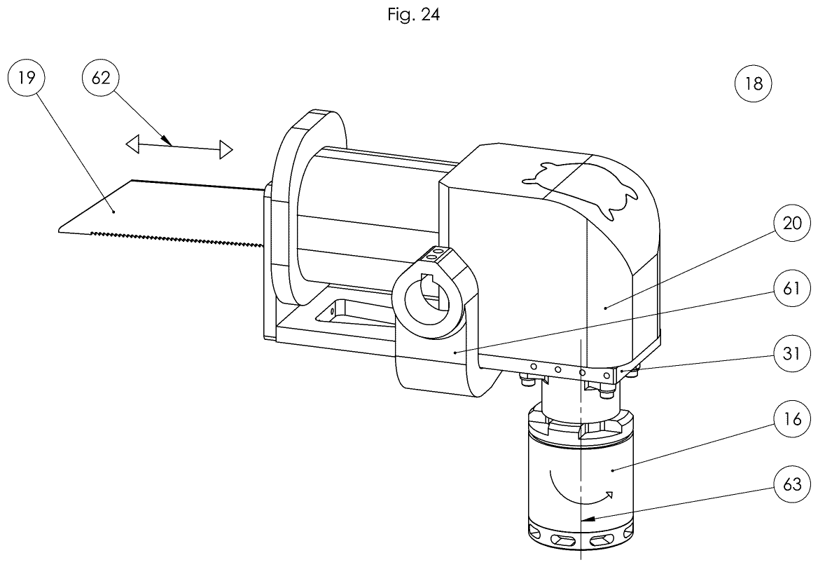

Referring to FIG. 24, illustrated is a perspective view of spacer cutting module [18] configured to remove spring spacer [3]. In some embodiments, spacer cutting module [18] can comprise of horizontal pivot mount [61] mechanically coupled to cutter support [31] to which reciprocating gearbox [20] can be mechanically secured. In some embodiments, the linear motion of blade [19] along arrow [62] can be substantially coupled to the rotary motion of motor [16] about axis [63] through reciprocating gearbox [20], as known by those skilled in the art. In some embodiments, the speed of blade [19] can be directly proportional to the rotation speed of motor [16], which can be commanded by computer [34].

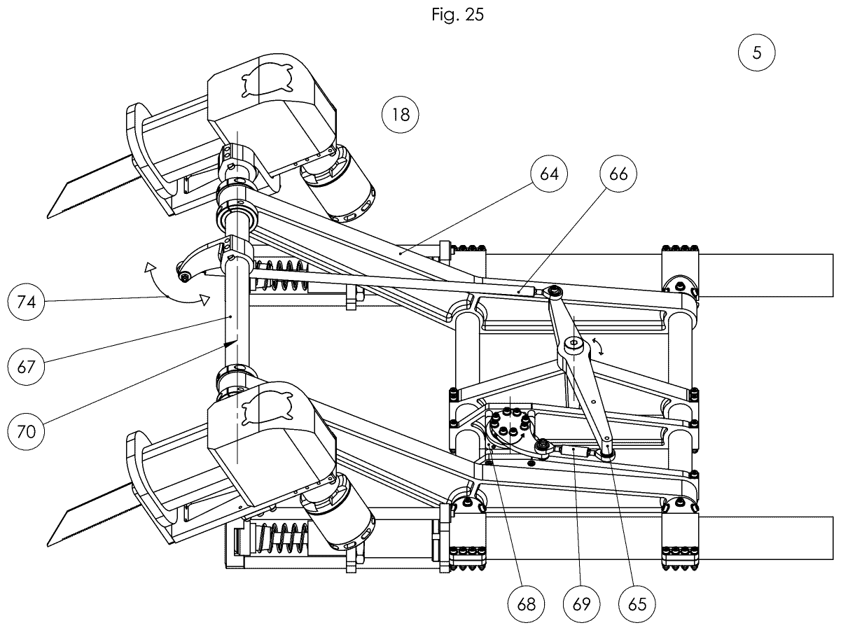

Referring to FIG. 25, illustrated is a perspective view of spacer removal assembly [5] in the removal of spring spacer [3]. This configuration can comprise of a plurality of elevated pivot supports [64], a plurality of spacer cutting modules [18], a rocker arm [65], a connecting linkage [66] a rotation bar [67], a rocker arm servo [68], and a servo linkage [69]. In this configuration, the plurality of spacer cutting module [18] can be rotationally locked to the rotation bar [67] such that the rotation of rotation bar [67] can directly translate to rotation of the plurality of spacer cutting module [18]. In some embodiments, rotation bar [67] can be supported in a plurality of bearings to allow rotation about axis [70] but no translation. In some embodiments, the rotation of rotation bar [67] about axis [70] in the direction of arrow [74], can be driven by a connecting linkage to rocker arm [65], such that rotation in rocker arm [65] can be proportional to rotation in rotation bar [67]. The rocker arm can be supported in the same way as previously described and its position is controlled by rocker arm servo [68] as previously described.

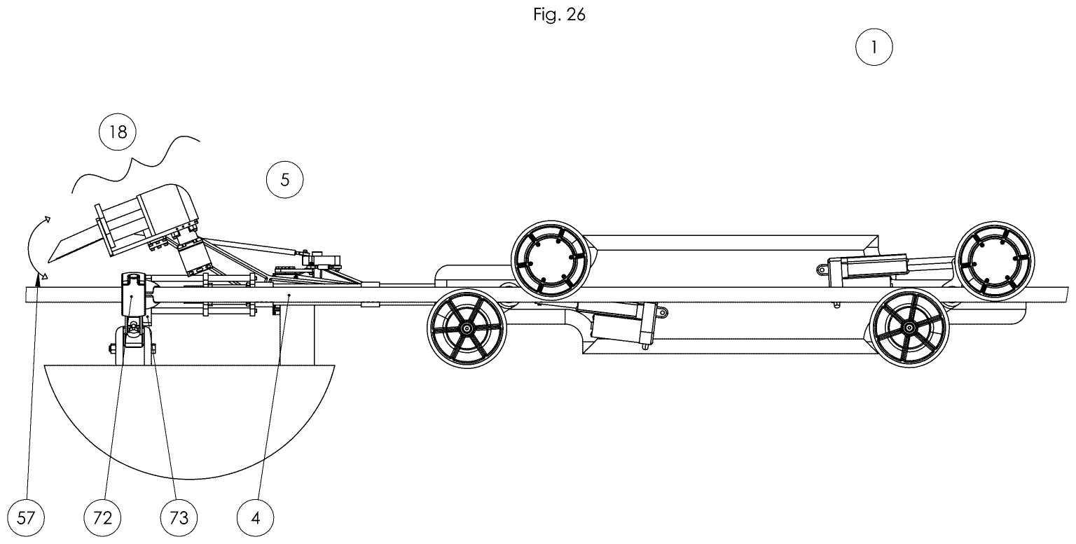

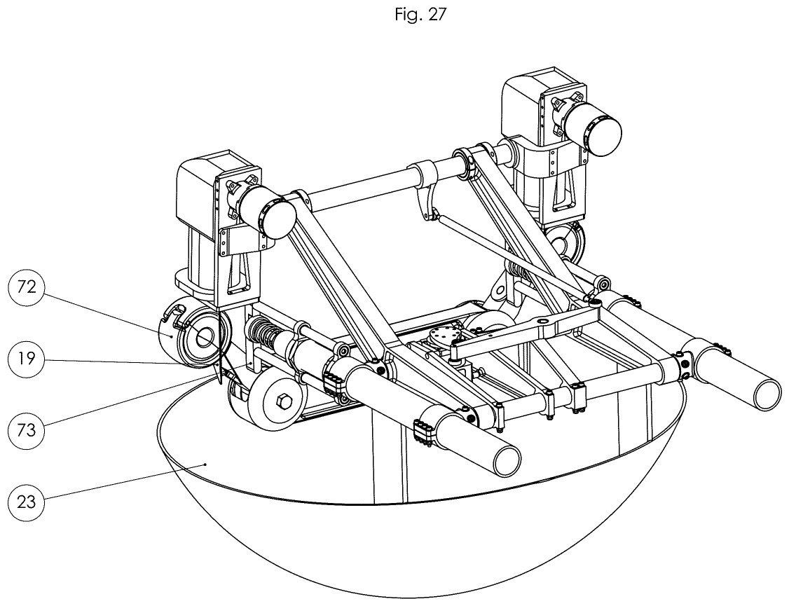

Referring to FIG. 26, illustrated is a side view of line spacer removal robot [1] on a set of dual wires [4] configured to remove one or more Dulmison® dual spacer [72]. The process of placing line spacer removal robot [1] on dual wires [4] is the same as described previously. In some embodiments, robot body assembly [6] can be the same as described previously and consists of the same components. When configured to remove a Dulmison® dual spacer [72], spacer remover assembly [5] can be predominantly similar as when it is configured to remove a spring spacer [3], with the key difference being extended bump stops [73] which are longer due to the dropped down nature of the Dulmison® dual spacer [72]. The process of removing a spring spacer [3] and Dulmison® dual spacer [72] is the same, wherein the plurality of spacer cutting module [18] can rotate synchronously following cutting arrow [57]. As shown in FIG. 27, this cutting motion can continue until the plurality of blades [19] cut through each side of Dulmison® dual spacer [72]. In this figure, dual wires [4] and robot body assembly [6] are not shown for clarity. Once each side of Dulmison® dual spacer [72] is cut, all rigidity therein will be lost and it can fall into bucket [23].

Referring to FIG. 28, illustrated is a clear view of Dulmison® dual spacer [72] after it has been cut by the plurality of spacer cutting modules [18] and is falling into bucket [23]. Upon removal from the dual wires [4], Dulmison® dual spacer [72] can comprise of multiple pieces, all of which will fall into bucket [23]. In this figure, line spacer removal robot [1] and its components are not shown for clarity.

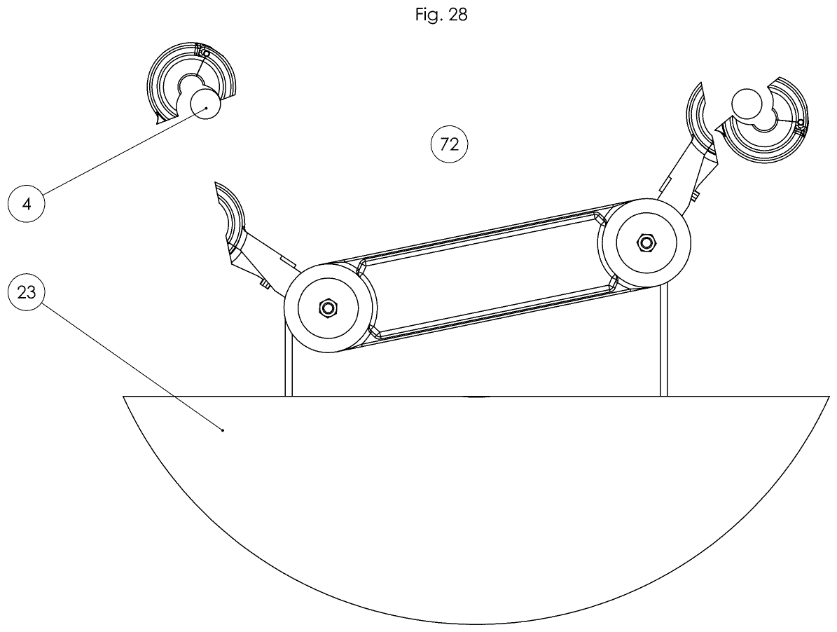

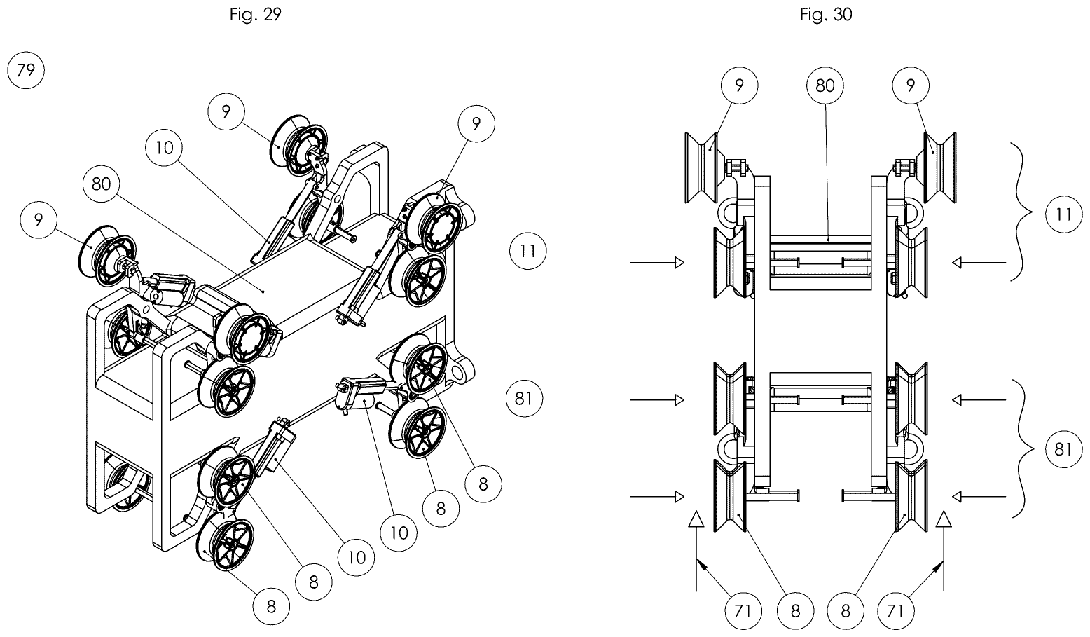

Referring to FIGS. 29 and 30, illustrated is part of the initial step of putting quad spacer removal robot [75] on a set of quad wires [77]. In some embodiments, quad spacer removal robot [75] can be installed on quad wires [77] in a similar fashion to line spacer removal robot [1], and can be done by a worker using a bucket truck or crane man basket to elevate quad spacer removal robot [75] and the worker can install quad spacer removal robot on the conductor bundles, as is known to those skilled in the art. In these figures, quad spacer removal assembly [78] is not shown for clarity. FIG. 29 shows a perspective view of the contents of quad robot body assembly [79]. In some embodiments, quad robot body assembly [79] can comprise of quad robot body [80], a plurality of buggy wheel assembly [11], each of which can comprise a retractor wheel [8], top wheel [9] and actuator [10], and a plurality of retractor buggy wheel assembly [81], which can comprise of two retractor wheels [8] and an actuator [10]. FIG. 30 shows the retracted state of each of retractor wheels [8]. In some embodiments, the plurality of retractor wheels [8] can be positioned in the retracted state for case of placement onto a set of quad wires [77].

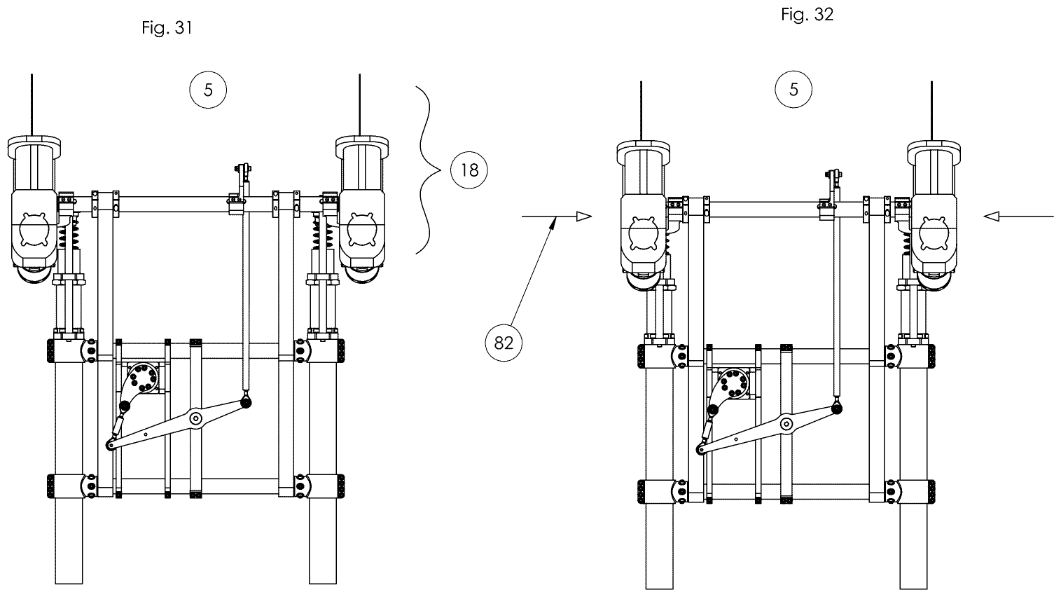

Referring to FIGS. 31 and 32, illustrated is the retractable nature of spacer removal assembly [5], which is necessary to fit through quad wires [77]. In some embodiments, spacer cutting module on either side of spacer removal assembly [5] can be manually moved towards the center in the direction of arrow [82] to give enough clearance to fit in between the spans of wire in the conductor bundle. The retraction of spacer cutting module [18] can be combined with that of the plurality of retractor wheels [8] can complete the preparation in order for quad spacer removal robot [75] to be placed on the set of quad wires [77]. In some embodiments, retractor wheels [8] and bottom spacer removal assembly [5] of quad spacer removal assembly [78] can fit inside of quad wires [77] and quad spacer removal robot [75] can be lowered down until top wheels [9] of buggy wheel assembly [11] meet and rest upon quad wires [77]. As quad spacer removal robot [75] is lowered down, quad wires [77], with respect to the quad spacer removal robot [75], can follow the path shown by arrow [71] in FIG. 30 until contact is made with top wheels [9].

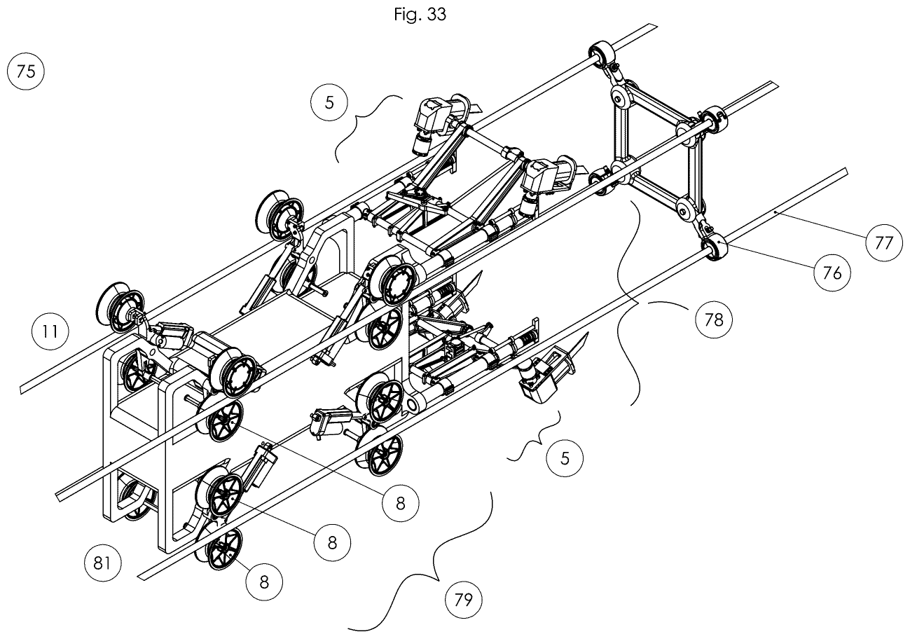

Referring to FIG. 33, illustrated is a perspective view of the entirety of quad spacer removal robot [75] placed on a set of quad wires [77] with retractor wheels [8] still retracted. In some embodiments, quad spacer removal robot [75] can comprise of two main assemblies, those being, quad robot body assembly [79] and quad spacer removal Assembly [78]. In some embodiments, quad spacer removal assembly [78] can comprise of two spacer removal assemblies [5] attached to quad robot body assembly [79] and mirrored about the horizontal plane making one face vertically upwards, and the other one facing downwards. In some embodiments, the plurality of spacer removal assembly [5] making up quad spacer removal assembly [78] can be in the same configuration required to remove a Dulmison® dual spacer [72]. The composition and functionality of each spacer removal assembly [5] can be the same as described previously above. In some embodiments, the plurality of buggy wheel assembly [11] and retractor buggy wheel assembly [81] can be configured in an open state and quad spacer removal robot [75] can be positioned at a distance from quad spacer [75] that is clamped between the set of quad wires [77].

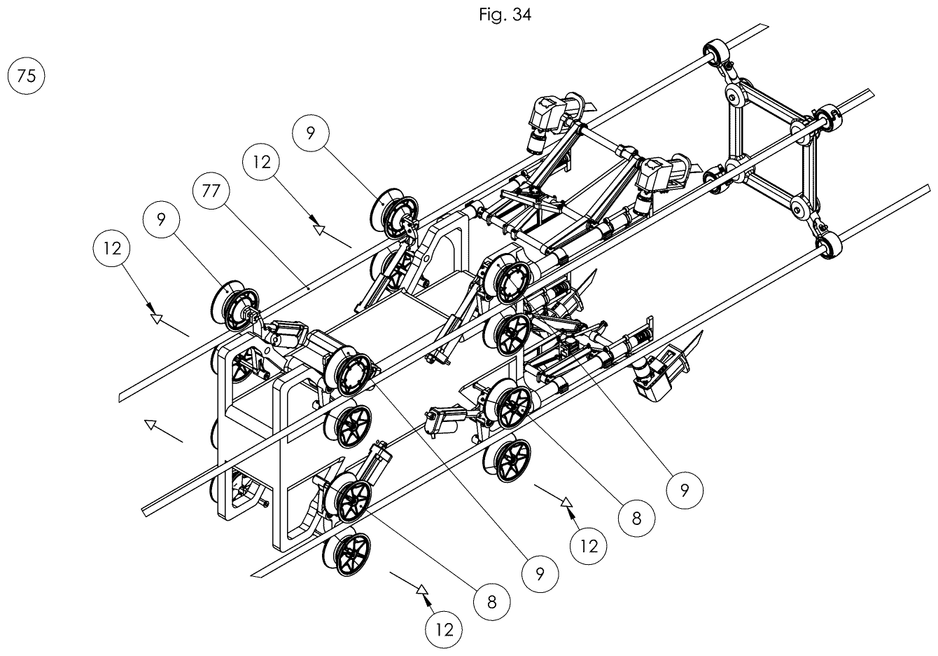

Referring to FIG. 34, illustrated is a perspective view as shown in FIG. 33, but with retractor wheels [8] in the extended position. In some embodiments, retractor wheels [8] can extend in the direction of retractor wheel arrow [12] until they become flush with top wheels [9]. In some embodiments, retractor wheels [8] can be extended manually or can be fitted with suitable actuators to enable electronics inside quad spacer removal robot [75] to extend the wheels when commanded wirelessly. Once quad spacer removal robot [75] has reached this position, a full connection can be established with the quad wires [77].

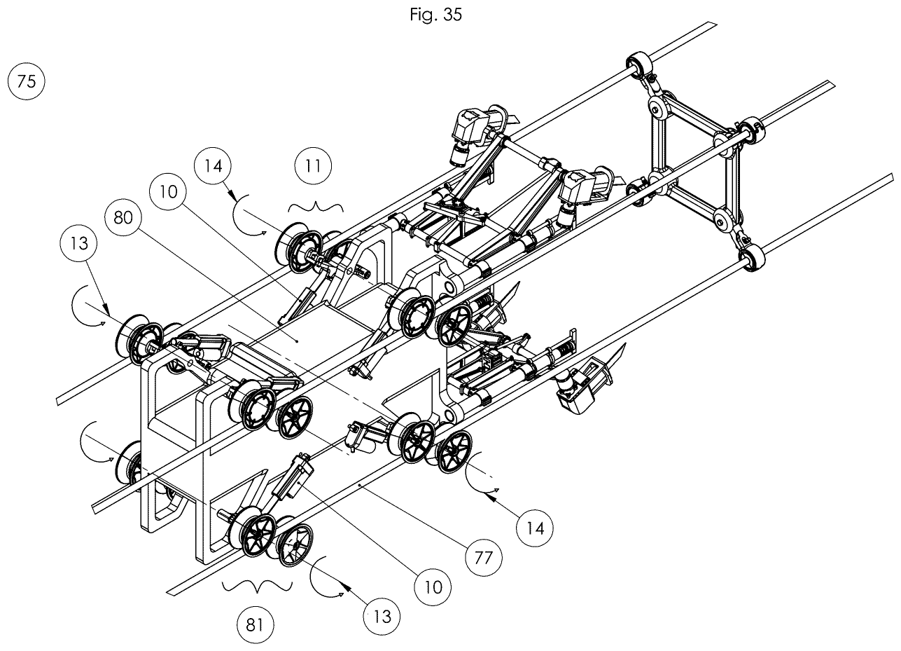

Referring to FIG. 35, illustrated is a perspective view of quad spacer removal robot [75] with a fully established connection to quad wires [77]. This connection can be established through the rotation of the plurality of buggy wheel assembly [11] and retractor buggy wheel assembly [81], driven by respective actuators [10] to clamp down on quad wires [77]. In some embodiments, the plurality of buggy wheel assembly [11] and retractor buggy wheel assembly [81] can rotate about buggy wheel axis [13] in the direction of buggy wheel arrow [14] until a sufficient torque is reached that can maintain a solid connection between quad wires [77] and quad spacer removal robot [75]. Each actuator [10] can be driven by internally located electronics disposed within quad robot body [80] and can be commanded wirelessly by an operator over a radio communication link.

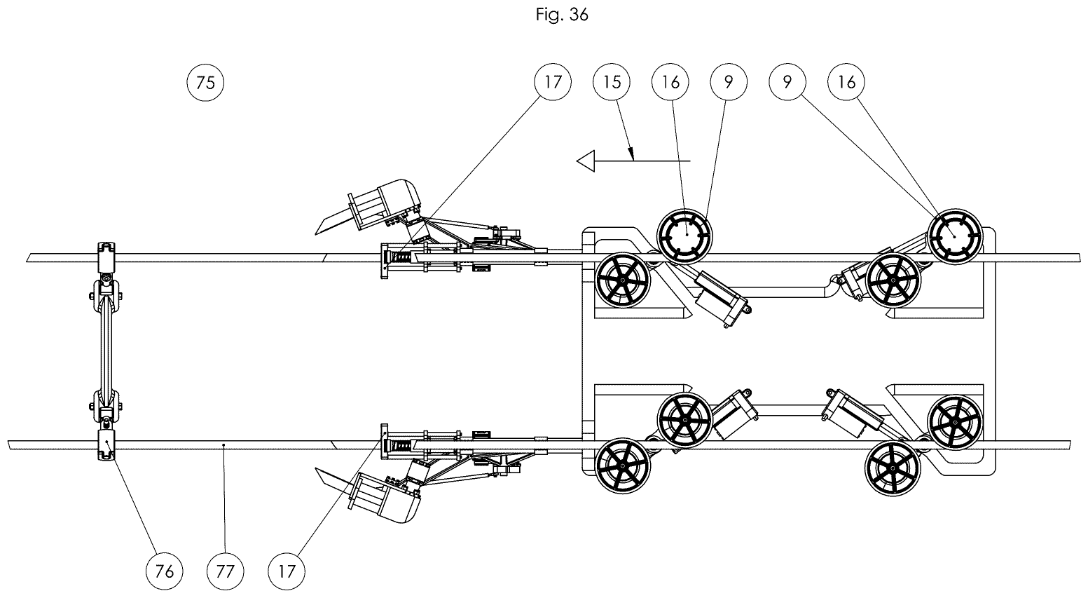

Referring to FIG. 36, illustrated is a side view of quad spacer removal robot [75] driving on quad wires [77] along arrow [15] towards quad spacer [76]. This motion can bee achieved in the same manner as previously described for line spacer removal robot [1]. The plurality of internally located motor [16] within each of top wheels [9] can be wirelessly commanded by an operator to drive forward until bump stops [17] spacer removal assembly [5] in quad spacer removal assembly [79] comes into contact with quad spacer [76].

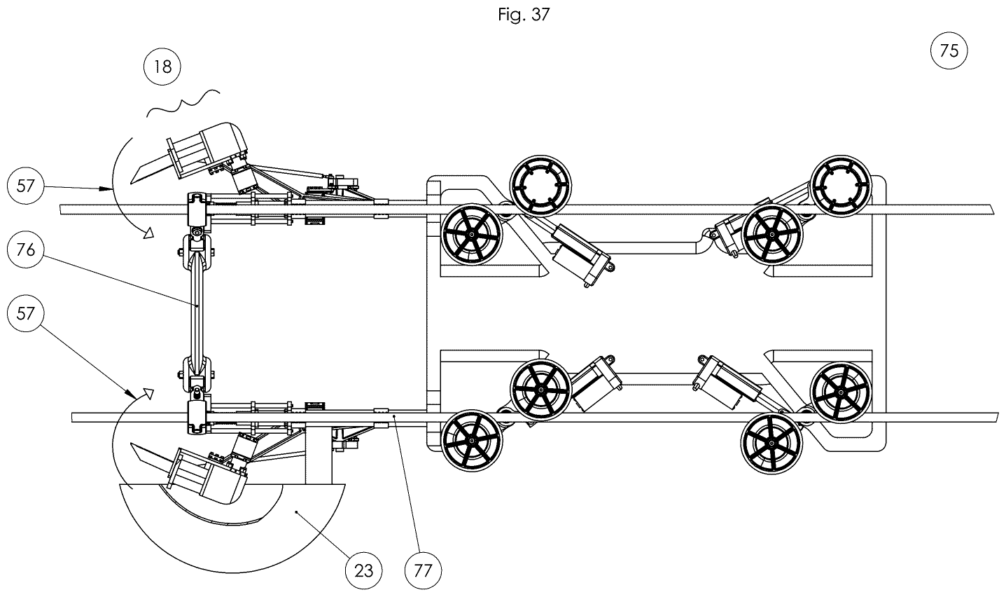

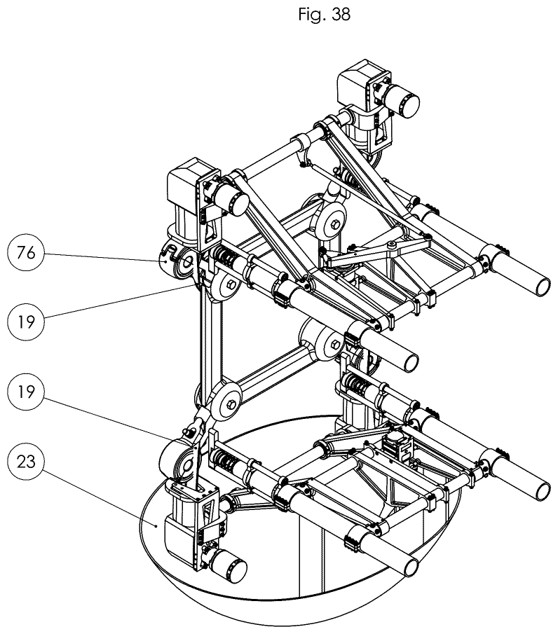

Referring to FIG. 37, illustrated is a side view of quad spacer removal robot [75] as well as a plurality of spacer cutting module [18], whose contents can remain the same as previously described. The process to remove quad spacer [76] is similar to that of spring spacer [3] or Dulmison® dual spacer [72] wherein the plurality of cutting module [18] can rotate along cutting arrow [57] to cut through the four points of contact that quad spacer [76] makes with quad wires [77]. In this figure, bucket [23] is shown for the purpose of catching the contents of quad spacer [76] as it is removed from and falls off of quad wires [76]. As shown in FIG. 38, the cutting motion taken along cutting arrow [57] can continue until the plurality of blades [19] cut through the four points of contact between quad spacer [76] and quad wires [77] at which point quad spacer [76] is no longer attached to the conductor bundle and will fall into the bucket [23]. In this figure, quad wires [77], and quad robot body assembly [79] are not shown for clarity.

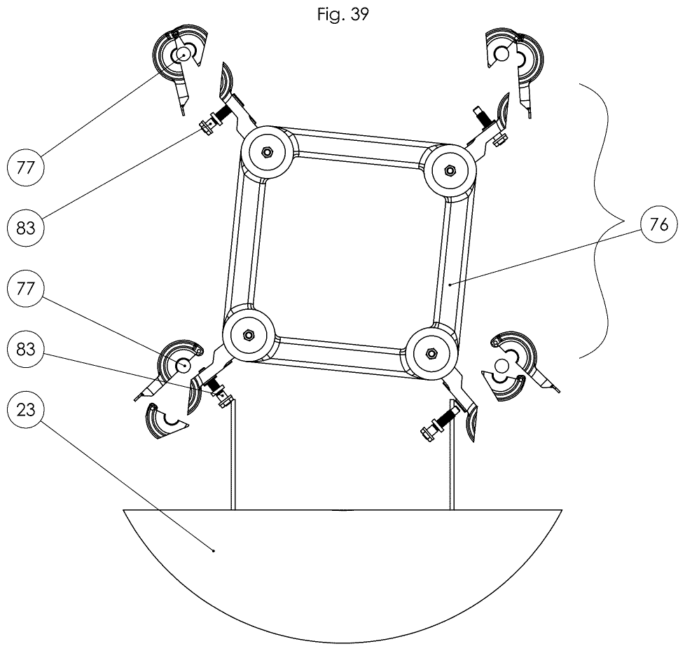

Referring to FIG. 39, illustrated is a view of quad spacer [76] after it has been cut and released from quad wires [77] and is falling into bucket [23]. Upon the completion of cutting, quad spacer [76] will comprise of multiple pieces, including four quad spacer bolts [83] all of which will fall into bucket [23]. In this figure, quad spacer removal robot [75] and its components are not shown for clarity.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described herein, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

We claim:

1. An apparatus for removing a line spacer from a plurality of wires, the apparatus comprising:
a) a body assembly comprising a front side and a rear side, and further comprising a pair of adjacent sides disposed between the front side and the rear side, the body assembly comprising a plurality of support tubes extending from the front side, the body assembly further comprising at least one cross bar disposed between the plurality of support tubes;
b) a plurality of buggy wheel assemblies disposed on the body assembly, the buggy wheel assemblies configured for placement on the plurality of wires and for conveying the apparatus along the plurality of wires; and
c) a spacer removal assembly disposed on at least one cross bar, the spacer removal assembly configured for cutting the line spacer from the plurality of wires.

2. The apparatus as set forth in claim 1, wherein the plurality of buggy wheel assemblies comprises a first set of the plurality of buggy wheel assemblies disposed near the front side of the body assembly and a second set of the plurality of buggy wheel assemblies disposed near the rear side of the body assembly.

3. The apparatus as set forth in claim 2, wherein each of the plurality of buggy wheel assemblies comprises:
a) a top wheel for resting on top of one of the plurality of wires;
b) a retractor wheel disposed beneath the one of the plurality of wires when the apparatus is placed on the plurality wires; and
c) an actuator for retracting and extending the retractor wheel towards and away from the one of the plurality of wires, wherein retracting the retractor wheel into contact with the one of the plurality of wires and rotation of the top wheel conveys the apparatus along the plurality of wires.

4. The apparatus as set forth in claim 3, wherein the top wheel comprises an electric motor disposed therein for rotating the top wheel.

5. The apparatus as set forth in claim 1, wherein the spacer removal assembly comprises at least one pair of cutting modules rotatably attached to the at least one cross bar.

6. The apparatus as set forth in claim 5, wherein each of the at least one pair of cutting modules comprises a reciprocating blade for cutting the line spacer when the at least one pair of cutting modules are rotated on the at least one cross bar towards the line spacer.

7. The apparatus as set forth in claim 6, wherein the spacer removal assembly comprises a rocker arm rotatably coupled to the at least one cross bar, the rocker arm rotatable about an axis orthogonal to the plurality of wires, the rocker arm operatively coupled to two of the at least one pair of cutting modules via connecting linkage connected thereto wherein rotation of the rocker arm rotates the at least one pair of cutting modules on the at least one cross bar towards and away from the line spacer.

8. The apparatus as set forth in claim 6, each of the at least one pair of cutting modules comprises a pivot assembly for rotating the reciprocating blade about a longitudinal axis of the reciprocating blade.

9. The apparatus as set forth in claim 8, wherein the pivot assembly comprises:
a) a pivot mount rotatably disposed on the at least one cross bar;
b) a pinion gear rotatably coupled to a pinion gear servo disposed on the pivot mount; and
c) a ring gear disposed on each of the at least one pair of cutting modules, the pinion gear engaged with the ring gear wherein rotation of the pinion gear rotates each of the at least one pair of cutting modules.

10. The apparatus as set forth in claim 1, wherein the line spacer comprises one of a single bolt spacer, a spring spacer, a Dulmison® spacer, and a quad spacer.

11. A method for removing a line spacer from a plurality of wires, the method comprising:
a) placing an apparatus on the plurality of wires, the apparatus comprising:
i) a body assembly comprising a front side and a rear side, and further comprising a pair of adjacent sides disposed between the front side and the rear side, the body assembly comprising a plurality of support tubes extending from the front side, the body assembly further comprising at least one cross bar disposed between the plurality of support tubes,
ii) a plurality of buggy wheel assemblies disposed on the body assembly, the buggy wheel assemblies configured for placement on the plurality of wires and for conveying the apparatus along the plurality of wires, and
iii) a spacer removal assembly disposed on at least one cross bar, the spacer removal assembly configured for cutting the line spacer from the plurality of wires;
b) conveying the apparatus on the plurality of wires towards the line spacer; and
c) cutting the line spacer from the plurality of wires.

12. The method as set forth in claim 11, wherein the plurality of buggy wheel assemblies comprises a first set of the plurality of buggy wheel assemblies disposed near the front side of the body assembly and a second set of the plurality of buggy wheel assemblies disposed near the rear side of the body assembly.

13. The method as set forth in claim 12, wherein each of the plurality of buggy wheel assemblies comprises:
a) a top wheel for resting on top of one of the plurality of wires;
b) a retractor wheel disposed beneath the one of the plurality of wires when the apparatus is placed on the plurality wires; and
c) an actuator for retracting and extending the retractor wheel towards and away from the one of the plurality of wires, wherein retracting the retractor wheel into contact with the one of the plurality of wires and rotation of the top wheel conveys the apparatus along the plurality of wires.

14. The method as set forth in claim 13, wherein the top wheel comprises an electric motor disposed therein for rotating the top wheel.

15. The method as set forth in claim 11, wherein the spacer removal assembly comprises at least one pair of cutting modules rotatably attached to the at least one cross bar.

16. The method as set forth in claim 15, wherein each of the at least one pair of cutting modules comprises a reciprocating blade for cutting the line spacer when the at least one pair of cutting modules are rotated on the at least one cross bar towards the line spacer.

17. The method as set forth in claim 16, wherein the spacer removal assembly comprises a rocker arm rotatably coupled to the at least one cross bar, the rocker arm rotatable about an axis orthogonal to the plurality of wires, the rocker arm operatively coupled to two of the at least one pair of cutting modules via connecting linkage connected thereto wherein rotation of the rocker arm rotates the at least one pair of cutting modules on the at least one cross bar towards and away from the line spacer.

18. The method as set forth in claim 16, each of the at least one pair of cutting modules comprises a pivot assembly for rotating the reciprocating blade about a longitudinal axis of the reciprocating blade.

19. The method as set forth in claim 18, wherein the pivot assembly comprises:
a) a pivot mount rotatably disposed on the at least one cross bar;
b) a pinion gear rotatably coupled to a pinion gear servo disposed on the pivot mount; and
c) a ring gear disposed on each of the at least one pair of cutting modules, the pinion gear engaged with the ring gear wherein rotation of the pinion gear rotates each of the at least one pair of cutting modules.

20. The method as set forth in claim 11, wherein the line spacer comprises one of a single bolt spacer, a spring spacer, a Dulmison® spacer, and a quad spacer.
